(19) United States
(12) Patent Application Publication
(10) Pub. No.: US 2022/0408658 A1
(43) Pub. Date: Dec. 29, 2022

(54) METHOD OF GROWING A PLANT HAVING AT LEAST ONE LIGHT ABSORBING PIGMENT

(71) Applicant: THE ROYAL INSTITUTION FOR THE ADVANCEMENT OF LEARNING / MCGILL UNIVERSITY, Montréal (CA)

(72) Inventors: Mark LEFSRUD, Hudson (CA); Bo-Sen WU, Saint-Laurent (CA); Srinivasa REDDY, Ste-Anne-de-Bellevue (CA); Michael SCHWALB, Langford (CA)

(21) Appl. No.: 17/762,522

(22) PCT Filed: Sep. 24, 2020
(86) PCT No.: PCT/CA2020/051277

§ 371 Date: Mar. 22, 2022

Related U.S. Application Data
(60) Provisional application No. 62/904,908, filed on Sep. 24, 2019.

(51) Int. Cl. A01G 9/14

(52) U.S. Cl. CPC A01G 9/1438

(57) ABSTRACT

There is described a method of growing a plant having at least one light absorbing pigment, the at least one light absorbing pigment absorbing optical energy at absorbing wavelengths. The method generally has illuminating the plant growing light, the growing light having optical energy within at least two spectral regions each encompassing a given wavelength, the given wavelengths being out of tune with the absorbing wavelengths of the at least one light absorbing pigment, the at least two spectral regions being selected from a group consisting of a first spectral region below 400 nm, a second spectral region at about 430 nm, a third spectral region at about 480 nm, a fourth spectral region at about 595 nm, a fifth spectral region at about 640 nm, a sixth spectral region at about 660 nm and a seventh spectral region at about 675 nm.

### FIELD

The improvements generally relate to photosynthesis and more specifically relate to methods of illuminating plants in a manner increasing a biomass yield and/or a net photosynthetic rate.

### BACKGROUND

It is generally accepted in the field that to grow plants, the plants should preferably be illuminated with a light beam having optical energy within spectral regions encompassing wavelengths which are specifically directed to absorbing wavelengths of light absorbing pigments of the plants. Although existing plant growing techniques are satisfactory to a certain degree, there remains room for improvement.

### SUMMARY

It was found that biomass yield and/or net photosynthetic rate can be increased by controlling the spectral content of the light used to grow plants. Specifically, it was found that biomass yield and/or net photosynthetic rate increases can be achieved by illuminating the plants with growing light having spectral content that is out of tune with the absorbing wavelengths of the light absorbing pigments of the plants.

As some well-known absorbing pigments have absorbing wavelengths at some specific wavelengths values and/or ranges (e.g., ˜400-420 nm, ˜440-460 nm, ˜500-590 nm, ˜600-630 nm, ˜645-650 nm, and 670 nm), it was found convenient to illuminate the plants with growing light having optical energy within at least two spectral regions selected from the group consisting of <400 nm, ˜430 nm, ˜480 nm, ˜595 nm, ˜640 nm, ˜660 nm and ˜675 nm. By limiting the spectral content of the growing light where it actually counts, the biomass yield and/or net photosynthetic rate can be increased.

In accordance with a first aspect of the present disclosure, there is provided a method of growing a plant having at least one light absorbing pigment, the at least one light absorbing pigment absorbing optical energy at absorbing wavelengths, the method comprising: illuminating the plant with growing light, the growing light having optical energy within at least two spectral regions each encompassing a given wavelength, the given wavelengths being out of tune with the absorbing wavelengths of the at least one light absorbing pigment, the at least two spectral regions being selected from a group consisting of a first spectral region below 400 nm, a second spectral region at about 430 nm, a third spectral region at about 480 nm, a fourth spectral region at about 595 nm, a fifth spectral region at about 640 nm, a sixth spectral region at about 660 nm and a seventh spectral region at about 675 nm.

Further in accordance with the first aspect of the present disclosure, the growing light can for example include a first light beam having optical energy within one of the at least two selected spectral regions and a second light beam having optical energy within a remaining one of the at least two selected spectral regions.

Still further in accordance with the first aspect of the present disclosure, said illuminating can for example comprise generating the first light beam using a first light-emitting diode and generating the second light beam using a second light-emitting diode.

Still further in accordance with the first aspect of the present disclosure, said illuminating can for example further comprise filtering the first light beam in a manner filtering out optical energy being out of tune with the one of the at least two selected spectral regions and filtering the second light beam in a manner filtering out optical energy being out of tune with the remaining one of the at least two selected spectral regions.

Still further in accordance with the first aspect of the present disclosure, at least one of the at least two selected spectral regions can for example have a bandwidth of at least 1 nm.

Still further in accordance with the first aspect of the present disclosure, the at least one light absorbing pigment can for example include at least one of chlorophyll a, chlorophyll b, carotenoid and anthocyanin.

Still further in accordance with the first aspect of the present disclosure, the at least two selected spectral regions can for example not overlap with one another.

Still further in accordance with the first aspect of the present disclosure, said illuminating can for example include receiving sunlight and filtering the sunlight to remove the absorbing wavelengths of the at least one light absorbing pigment to provide the growing light.

In accordance with a second aspect of the present disclosure, there is provided a method of growing a plant, the method comprising: illuminating the plant with growing light, the growing light having optical energy within at least two spectral regions being selected from a group consisting of a first spectral region below 400 nm, a second spectral region at about 430 nm, a third spectral region at about 480 nm, a fourth spectral region at about 595 nm, a fifth spectral region at about 640 nm, a sixth spectral region at about 660 nm and a seventh spectral region at about 675 nm.

In accordance with a third aspect of the present disclosure, there is provided a system for growing a plant having at least one light absorbing pigment, the at least one light absorbing pigment absorbing optical energy at absorbing wavelengths, the system comprising: an illuminator illuminating the plant with growing light, the growing light having optical energy within at least two spectral regions each encompassing a given wavelength, the given wavelengths being out of tune with the absorbing wavelengths of the at least one light absorbing pigment, the at least two spectral regions being selected from a group consisting of a first spectral region below 400 nm, a second spectral region at about 430 nm, a third spectral region at about 480 nm, a fourth spectral region at about 595 nm, a fifth spectral region at about 640 nm, a sixth spectral region at about 660 nm and a seventh spectral region at about 675 nm.

Further in accordance with the third aspect of the present disclosure, the illuminator can for example include a first illumination device propagating a first light beam having optical energy within one of the at least two selected spectral regions and a second illumination device propagating a second light beam having optical energy within a remaining one of the at least two selected spectral regions.

Still further in accordance with the third aspect of the present disclosure, said first illumination device can for example be a first light-emitting diode and said second illumination device can for example be a second light-emitting diode.

Still further in accordance with the third aspect of the present disclosure, said first illumination device can for example have one or more filter elements filtering the first light beam in a manner filtering out optical energy being out of tune with the one of the at least two selected spectral regions, the second illumination device having one or more filter elements filtering the second light beam in a manner filtering out optical energy being out of tune with the remaining one of the at least two selected spectral regions.

In accordance with a fourth aspect of the present disclosure, there is provided a shelter for growing plants using sunlight, the plants having at least one light absorbing pigment absorbing optical energy at absorbing wavelengths, the shelter comprising: one or more supports; and one or more sheltering elements supported by the one or more supports and defining an area where plants are planted, the sheltering elements receiving the sunlight and filtering the sunlight to remove optical energy at the absorbing wavelengths of the at least one light absorbing pigment, thereby leaving a remaining portion of the sunlight to reach the plants, the remaining portion of the sunlight having optical energy within at least two spectral regions being selected from a group consisting of a first spectral region below 400 nm, a second spectral region at about 430 nm, a third spectral region at about 480 nm, a fourth spectral region at about 595 nm, a fifth spectral region at about 640 nm, a sixth spectral region at about 660 nm and a seventh spectral region at about 675 nm.

Further in accordance with the fourth aspect of the present disclosure, said sheltering elements can for example be partially or wholly made of a transparent layer being optically transparent only at the at least spectral regions.

Still further in accordance with the fourth aspect of the present disclosure, the transparent layer can for example have a body of sunlight transparent material, and one or more filter elements deposited on the body of sunlight transparent material, the filter elements filtering the sunlight to remove optical energy at the absorbing wavelengths of the at least one light absorbing pigment.

In accordance with a fifth aspect of the present disclosure, there is provided a method of growing a plant having at least one light absorbing pigment, the at least one light absorbing pigment absorbing optical energy at absorbing wavelengths, the method comprising: illuminating the plant with growing light, growing light having optical energy within one or more spectral regions each encompassing a given wavelength being out of tune with the absorbing wavelengths of the at least one light absorbing pigment.

Many further features and combinations thereof concerning the present improvements will appear to those skilled in the art following a reading of the instant disclosure.

### DESCRIPTION OF THE FIGURES

In the figures,

FIG. 1 is a schematic view of an example of a system for growing a plant having one or more light absorbing pigments by illuminating the plant with growing light, in accordance with one or more embodiments;

FIG. 1A is a graph showing optical energy as function of wavelength for the growing light of FIG. 1, in accordance with one or more embodiments;

FIG. 2 is a graph showing net photosynthetic rate as function of wavelength when tomato and lettuce leaves are illuminated with the growing light of FIG. 1, in accordance with one or more embodiments;

FIG. 3 is an example of a greenhouse use to grow plants, showing spectral filters made integral to a roof of the greenhouse, in accordance with one or more embodiments;

FIG. 4 is a graph showing fresh masses of tomato plants grown under growing light of different spectral content, in accordance with one or more embodiments;

FIG. 5 is a schematic view of an illumination system used to illuminate a plant with growing light of different spectral content, in accordance with one or more embodiments;

FIG. 6 is a graph showing relative spectral content of a narrow bandwidth growing light beam and of a 480-nm LED growing light beam filtered by a monochromator of the illumination system of FIG. 5, in accordance with one or more embodiments;

FIG. 7A shows an image of a lettuce leaf under illumination with a 530-nm growing light, in accordance with one or more embodiments;

FIG. 7B shows an image of a tomato leaf under illumination with a 505-nm growing light beam, in accordance with one or more embodiments;

FIG. 8 is a graph showing a photosynthetic response curve for the dark reaction (respiration) and light reaction (photosynthesis) for lettuce and tomato leaves, in accordance with one or more embodiments;

FIG. 9 is a graph showing 1-nm-resolution action spectrum curves of tomato and lettuce leaves from 406 nm to 670 nm, in accordance with one or more embodiments;

FIG. 10 is a graph comparing action spectra curves, where curves from early studies are re-drawn from original data and normalized to a maximum of 1, in accordance with one or more embodiments; and

FIGS. 11A-B are graphs showing 1-nm-resolution action spectra curves for tomato and lettuce leaves, with pigment absorbance spectrum, anthocyanin absorbance spectrum, and calculated photo damage efficiency, in accordance with one or more embodiments.

### DETAILED DESCRIPTION

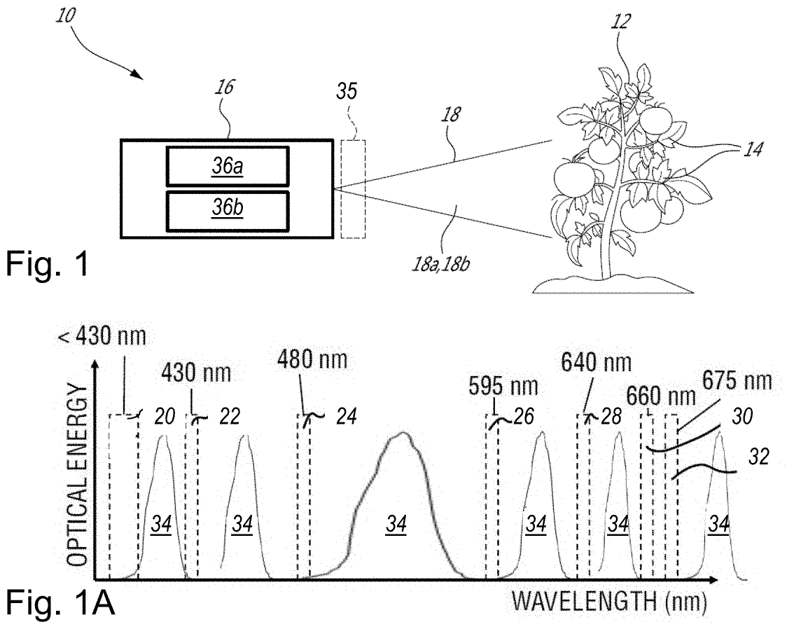

FIG. 1 shows an example of a system 10 for growing a plant 12 having one or more light absorbing pigments 14. Examples of such light absorbing pigments 14 can include chlorophyll a, chlorophyll b, carotenoids (e.g., lutein, β-carotene, zeaxanthin and lycopene), anthocyanin, and/or any other suitable light absorbing pigments.

In this example, a given one of the light absorbing pigments 14 of the plant 12 absorbs optical energy at known absorbing wavelengths. For instance, these absorbing wavelengths can include one or more of the following wavelength ranges or values: ˜400-420 nm, ˜440-460 nm, ˜500-590 nm, ˜600-630 nm, ˜645-650 nm, and 670 nm. As depicted, the system 10 has an illuminator 16 which is configured for illuminating the plant 12 with growing light (hereinafter “the growing light 18”). It was found that unexpected results (e.g., increased net photosynthetic rate, increased biomass yield) can be obtained when the growing light 18 has optical energy within at least two spectral regions each encompassing a given wavelength, where the given wavelengths are out of tune with the absorbing wavelengths of the given light absorbing pigment. With reference to FIG. 1A, the two or more spectral regions are selected from a group consisting of a first spectral region 20 below 400 nm, a second spectral region 22 at about 430 nm, a third spectral region 24 at about 480 nm, a fourth spectral region 26 at about 595 nm, a fifth spectral region 28 at about 640 nm, a sixth spectral region 30 at about 660 nm and a seventh spectral region 32 at about 675 nm.

As shown, the spectral regions 20, 22, 24, 26, 28, 30 and 32 are spectrally spaced from one another. Exemplary spectral absorption bands 34 representing the absorbing wavelengths of the given light absorbing pigment 14 are also shown in FIG. 1A. As can be seen, the spectral regions 20, 22, 24, 26, 28, 30 and 32 of the growing light beam 18 are substantially spectrally spaced from the absorbing wavelengths of the light absorbing pigment 14 of the plant 12. In some embodiments, the spectral regions 20, 22, 24, 26, 28, 30 and 32 do not overlap with one another. However, in some other embodiments, the spectral regions 20, 22, 24, 26, 28, 30 and 32 may have overlapping tails, i.e., overlapping spectral regions where optical energy of any two adjacent ones of the spectral regions 20, 22, 24, 26, 28, 30 and 32 have no or insignificant effect on plant growth.

In some embodiments, the system 10 can be configured to remove, or otherwise block, optical energy of the growing light beam 18 which lies within one or more spectral regions encompassing the absorbing wavelengths of the light absorbing pigments 14.

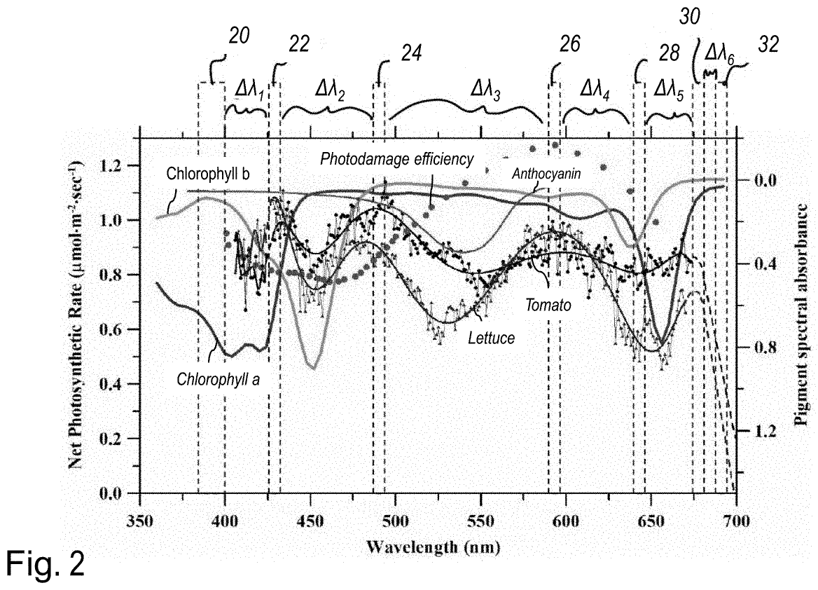

Examples of the unexpected results are shown in detail in FIG. 2. As depicted, in this example, the light absorbing pigments 14 of the plant 12 have first, second, third, fourth, fifth, and sixth spectral absorption bands Δλ1, Δλ2, Δλ3, Δλ4, Δλ5 and Δλ6. More specifically, the first spectral absorption band Δλ1 spans from about 400 nm to about 420 nm, the second spectral absorption band Δλ2 spans from about 440 nm to about 460 nm, the third spectral absorption band Δλ3 spans from about 500 nm to about 590 nm, the fourth spectral absorption band Δλ4 spans from about 600 to about 630 nm, the fifth spectral absorption band Δλ5 spans from about 645 nm to about 650 nm, the sixth spectral absorption band Δλ6 lies at about 670 nm. The skilled reader may appreciate that, in this example, the first absorption band Δλ1 spans between the ˜400-nm peak of chlorophyll a and the ˜425-nm peak of chlorophyll b. Accordingly, in this example, by illuminating the plant 12 with the growing light beam 18 having the first and second spectral regions 20 and 22 which are each spectrally spaced from the first, second and third spectral absorption bands Δλ1, Δλ2 and Δλ3 of the light absorbing pigments 14, satisfactory biomass and/or net photosynthetic growth rate increases can be obtained. However, it is intended that the growing light beam 18 can have optical power within any two, or more, of the spectral regions 20, 22, 24, 26, 28, 30 and 32, as long as they are out of tune with the absorbing wavelengths of the light absorbing pigment(s) 14 of the plant 12.

In some embodiments, the growing light beam 18 includes a first light beam 18a having optical energy at the first spectral region 20 and a second light beam 18b having optical energy at the second spectral region 22. In these embodiments, the first light beam 18 can be generated using a first light-emitting diode 36a and the second light beam can be generated using a second light-emitting diode 36b. However, in some other embodiments, any other suitable light source can be used such as a lamp, a laser and the like.

Moreover, the system 10 can have one or more filter elements 35 configured for filtering the first light beam 18a in a manner filtering out optical energy out of tune with the first spectral region 20 and for filtering the second light beam 18b in a manner filtering out optical energy out of tune with the second spectral region 22.

The spectral regions 20, 22, 24, 26, 28, 30 and 32 can have any suitable bandwidth. In some examples, the spectral regions 20, 22, 24, 26, 28, 30 and 32 are narrow-band. For instance, in some embodiments, the bandwidths of the spectral regions 20, 22, 24, 26, 28, 30 and 32 can be at least about 1 nm, about 5 nm, about 10 nm and the like.

Although not shown in FIG. 1, the growing light beam 18 can be focused on an area of the plant 12 in some alternate embodiments. Moreover, in some embodiments, light encompassing a visual region of the electromagnetic spectrum (e.g., about 400 nm to about 700 nm) can be shined onto the plant 12 so as to trigger mechanisms such as flowering of the plant 12 when desired, which would not necessarily be triggered solely using the growing light beam 18 having any two of the spectral regions 20, 22, 24, 26, 28, 30 and 32.

It is thus intended that the method presented herein can be used to grow a plant using growing light that has spectral content centered at valleys of the absorbance spectrum of the light absorbing pigment 14 of the plant 12, also referred to as “spectral regions” above. Earlier research has determined the spectral photosynthetic curve at 1-nm resolution in the visible spectrum (380-720 nm). The result indicated that photosynthetic machinery, i.e., biomass yield and/or net photosynthetic rate increases, has no or little correlation with the peaks of extracted pigment absorbance spectrum, but rather depends on the valleys as shown in FIG. 2. Research has identified seven such valleys in total: at below 400 nm, 430 nm, 480 nm (e.g., 460-500 nm), 595 nm, 640 nm, 660 nm (e.g., 650-670 nm) and greater than 675 nm. These valleys are based on the photosynthetic response of the plants and the light absorbance valleys of the light absorbing pigments of the plant. By including optical power within at least two of these seven valleys, it was shown that improved plant growth and photosynthesis can be achieved. Width of the valleys and ratios of the different valleys can vary from one embodiment to another. For instance, the first valley can have a bandwidth of ranging between 1 and 20 nm provided that the optical power be below 400 nm. The second valley can have a bandwidth ranging between 1 and 15 nm, preferably between 1 and 10 nm. The third valley can have a bandwidth ranging between 1 and 30 nm, preferably between 1 and 20 nm, and most preferably between 1 and 10 nm. The fourth valley can have a bandwidth ranging between 1 and 15 nm, preferably 1 and 10 nm. The fifth valley can have a bandwidth ranging between 1 and 20 nm, preferably between 1 and 15 nm, and most preferably between 1 and 10 nm. The sixth valley can have a bandwidth ranging between 1 and 15 nm, preferably between 1 and 10 nm and most preferably between 1 and 5 nm. The seventh valley can have a bandwidth ranging between 1 and 15 nm, preferably between 1 and 10 nm and most preferably 1 and 5 nm. It is intended that example bandwidths mentioned above are examples only, as these bandwidths can be lower or greater than the values mentioned-above in some specific embodiments. For instance, it has been observed that these valleys can shift slightly (+/−<10 nm in at least some cases) based on the environment that the plants are grown and how the plant pigments change their light absorption under these various external and internal (plant cell) conditions. By selecting wavelengths where the pigments do not absorb or have limited absorbance, growth rate can be maximized.

The spectral regions 20, 22, 24, 26, 28, 30 and 32 can shift spectrally based on the environment in which the plants are grown and/or based on how the light absorbing pigments of the plants change their light absorption under various external and/or internal (plant cell) conditions. It has been observed that these valleys can spectrally shift slightly (+/−<5 nm in at least some cases) between different plant species. In some embodiments, the peak of the spectral regions 20, 22, 24, 26, 28, 30 and 32 can spectrally shift by at least about 1 nm, about 5 nm, about 10 nm and the like, depending on the embodiment. For instance, the spectral region 22 can be located at 430 nm for lettuce plants and at 435 nm for tomato plants, respectively. The spectral region 24 can be located at 480 nm for lettuce plants and 495 nm for tomato plants, respectively. The spectral region 28 can be located at 645 nm for lettuce plants and 650 nm for tomato plants, respectively, under the same external environment. It is intended that the example peak wavelengths mentioned above are examples only, as these peak wavelengths can be lower or greater than the values mentioned-above in some specific embodiments.

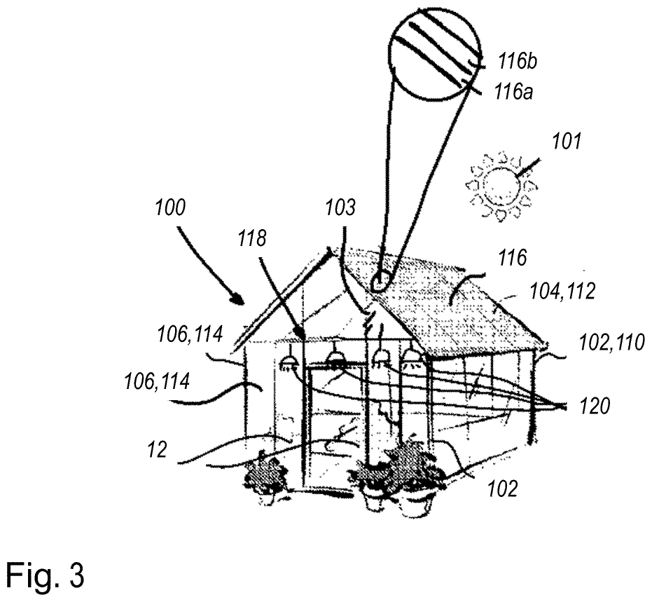

FIG. 3 shows an example of a shelter 100 for growing plants 12 using sunlight 101. As shown, the shelter 100 has one or more supports 102, and one or more sheltering elements 104 supported by the one or more supports 102, which collectively define a given area 106 where plants 12 are planted. In this specific example, the one or more supports 102 are provided in the form of lateral walls 110 whereas the one or more sheltering elements 104 are provided in the form of a roof 112. Accordingly, the lateral walls 110 and the roof 112 define a cavity 114 in which lies the given area 106.

As shown, the single sheltering element 104, in this case the roof 112, receives the sunlight 101 and filters the sunlight 101 to remove optical energy at the absorbing wavelengths of the at least one light absorbing pigment, thereby leaving a remaining portion 103 of the sunlight 101 to reach the plants 12. As can be understood, the remaining portion 103 of the sunlight 101 has optical energy within at least two spectral regions being selected from a group consisting of a first spectral region below 400 nm, a second spectral region at about 430 nm, a third spectral region at about 480 nm, a fourth spectral region at about 595 nm, a fifth spectral region at about 640 nm, a sixth spectral region at about 660 nm and a seventh spectral region at about 675 nm.

In some embodiments, the roof 112 is partially or wholly made of a transparent layer 116 which is optically transparent only at the selected spectral regions. In such embodiments, the transparent layer 116 has a body 116a of sunlight transparent material, and one or more filter elements 116b deposited on the body 116a of sunlight transparent material. Examples of such sunlight transparent material can include, but is not limited to, glass, polymer and the like. In this way, the filter elements 116b can filter the sunlight 101 to remove optical energy at the absorbing wavelengths of the at least one light absorbing pigment. In some embodiments, the shelter 100 can be provided in the form of a greenhouse inside which the plants 12 can grow by being illuminated with growing light such as defined above for increased productivity.

As shown in this example, the shelter 100 can be equipped with an illuminator 118 comprising one or more illuminating devices 120 to provide growing light as defined above to the plants 12 during the night or even during the day, alternately or additionally to the remaining portion 103 of the sunlight 101.

Example 1—The action spectrum of photosynthesis for tomato and lettuce leaves: 1-nm resolution at 30 μmol·m⁻²·sec⁻¹

The spectral quality for photosynthesis is well founded and has been investigated in higher plants for over 60 years. However, differences in action spectrum and quantum yield, with differently shaped curves and observed peaks have been reported. To date, the McCree curve is considered the standard photosynthetic response curve, but it was constructed with varying photosynthetic rates and a broad light spectrum (25 nm). Using this historical data as a baseline, the aim of this study was to collect repeated measurements of plant photosynthetic rates with a higher wavelength resolution. The action spectrum was measured with a light spectrum of 10 nm full width at half maximum (FWHM) and an intensity of 30 μmol·m⁻²·sec⁻¹, with data points taken every 1 nm, using 3-4 week old tomato and lettuce plants. After data collection and analysis, both species had action spectrum curves with two distinct peaks at 430 nm and 595 nm, and shoulders at 480 nm and 669 nm. These 1-nm action spectrum data do not correlate with the extracted pigment absorbance spectrum. Furthermore, photo-damage efficiency, which strongly associates with oxygen evolving complex (OEC) absorptance, accords with spectral photosynthetic data in the green light region (500-600 nm). We hypothesize that chlorophylls and other photo-pigments are used as light energy dissipaters and that initiation of photosynthetic capacity for 595-nm light is associated with the oxygen-evolving complex only. Data presented in this study provide the most precise information on the spectral quality of photosynthesis to date, shedding new light on our understanding of how photosynthesis occurs in plants.

The spectral quality of photosynthesis (action spectrum or/and quantum yield) in higher plants was initially determined using narrow light spectrum. These studies concluded that blue (400-500 nm) and red (600-700 nm) wavelengths are the most efficient light in the visible wavelength range (380-720 nm). To date, the most comprehensive and well-accepted photosynthesis data set is the McCree action spectrum curve, which has peak photosynthetic rates at 440 nm and 670 nm. Subsequent studies has confirmed this data, resulting in the selection of 460 nm and 650 nm light spectrum as the principally applied photosynthetic light for research and plant productivity. However, high pressure sodium (HPS) luminaires that predominately emit ˜595-nm light are still the industry standard. Blue/red light emitting diodes (LEDs), which emit “the most efficient light” for photosynthesis and plant growth, still cannot completely replace HPS luminaires as varied plant responses under the LED light have been reported. This raises the question: Why is the McCree curve still the definitive reference for light selection?

The objective of this research was to measure the action spectrum curve at every nanometer with a narrow light spectrum (10 nm FWHM) and 1-nm resolution, using the latest, high-irradiant colored LEDs and a high wavelength precision monochromator. This experiment focused on the spectral responses of tomato and lettuce plants across a wavelength range of 400-700 nm, at photosynthetic photon flux density of 30 μmol·m⁻²·sec⁻¹. Collected data provide the most precise information to date on the impact of specific wavelengths of light on photosynthesis in higher plants.

Tomato (Solanum lycopersicum ‘Beefsteak’, lot A1, OSC, Ontario, Canada) and lettuce (Lactuca sativa cv. Breen; pelleted MTO OG, Johnny's Selected Seeds, Winslow, Me.) seeds were germinated in rockwool growing cubes (Grodan A/S, Dk-2640, Hedehusene, Denmark) within a growth chamber (TC30, Conviron, Winnipeg, Canada). Overhead cool-white fluorescent bulbs (4200 K, F72T8CW, Osram, Wilmington, Mass.) provided a photosynthetic photon flux density (PPFD) of 150 μmol·m⁻²·sec⁻¹ (400-700 nm). The plants were exposed to the following environmental conditions: day/night temperatures 23/21±1° C., 16 h-photoperiod, and ambient CO₂ concentration. Aluminum foil was placed on the rockwool to prevent algae growth. Plants selected for photosynthetic measurements 21-30 days after seeding and emergence of the second true leaf to allow for a relatively reproducible symmetrical leaf and plant distribution. Plants were selected for consistency in size and age, while outliers were excluded from any further experimentation.

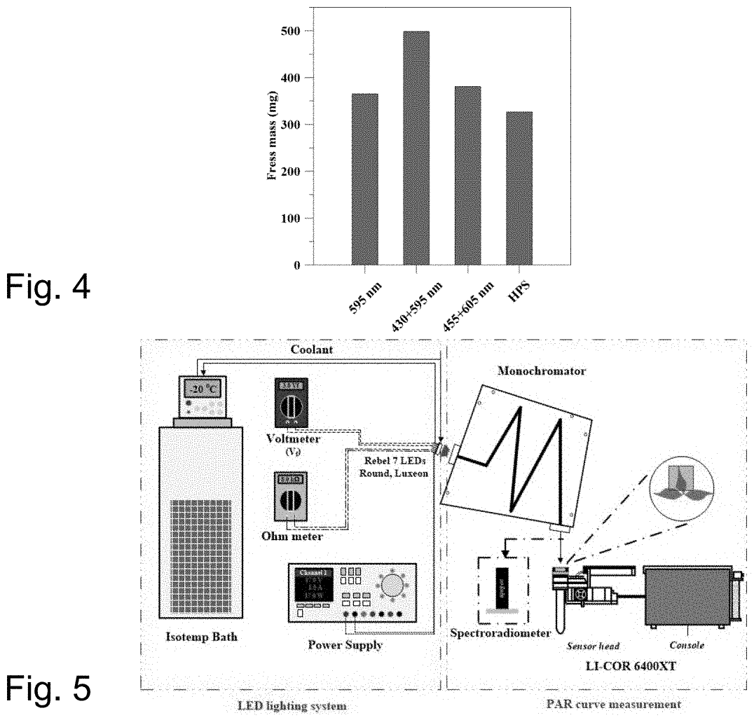

FIG. 4 is a graph showing fresh masses of tomato plants grown under growing light of different spectral contents. For instance, the bands of the histogram show fresh masses of tomato plants grown with growing light having a spectral region at about 595 nm light, with growing light having spectral regions at about 430 nm and at about 495 nm light, with growing light having spectral regions at about 455 nm and at about 605 nm and also with a growing light produced by high pressure sodium lamps. The 1-nm-resolution action spectrum curve measurements were taken with two apparatuses; a monochromatic lighting system and a photosynthetic measurement apparatus depicted in FIG. 5.

Monochromatic light with 10 nm FWHM, along with the test wavelength range were obtained from a filtered, colored LED light sources provided by a high precision monochromator (Model 74125, Newport, Irvine, Calif., US). Each colored LED assembly had a distinct color and peak wavelength. They were as follows: a 410 nm assembly (EFEV-1AE1, Edison Opto, Taiwan); a 447.5 nm LED assembly (LXML-PR01, Lumileds, Amsterdam, Netherlands); a 470 nm LED assembly (LXML-PB01, Lumileds); a 505 nm LED assembly (LXML-PE01, Lumileds), a 530 nm assembly (LXML-PM01, Lumileds), a 560 nm assembly (LXML-PX02, Lumileds), a 590 nm assembly (LXM2-PL01, Lumileds,), a 617 nm assembly (LXM2-PH01, Lumileds), a 627 nm assembly (LXM2-PD01, Lumileds), a 655 nm (LXM3-PD01, Lumileds), a 720 nm assembly (LXML-PF01, Lumileds); and a 735 nm assembly (ELSH-Q91LX, Everlight, Taiwan). Table 1 summarizes the optical characteristics and product attributes of the LED assemblies used in this study.

TABLE 1
LED assemblies used in this study.

| | Lumen (lm) | | Maximum | Maximum |
|---|---|---|---|---|
| Wavelength | or radiant | | forward | temperature |
| (nm) | power (mW) | FWHM (nm) | voltage (V) | (° C.) |
| 410 | — | | — | — |
| 448 | 9380 | 20 | 23.31 | |
| 470 | 672 | 20 | 23.73 | |
| 505 | 532 | 30 | 24.57 | 150 |
| 530 | 1358 | 30 | 24.57 | |
| 560 | 3220 | 100 | 19.25 | |
| 595 | 602 | 80 | 24.57 | |
| 617 | 1126 | 20 | 18.2 | |
| 627 | 826 | 20 | 18.2 | 135 |
| 655 | 4788 mW | 20 | 19.6 | |
| 720 | 3360 mW | 20 | 16.8 | |
| 735 | — | | — | — |

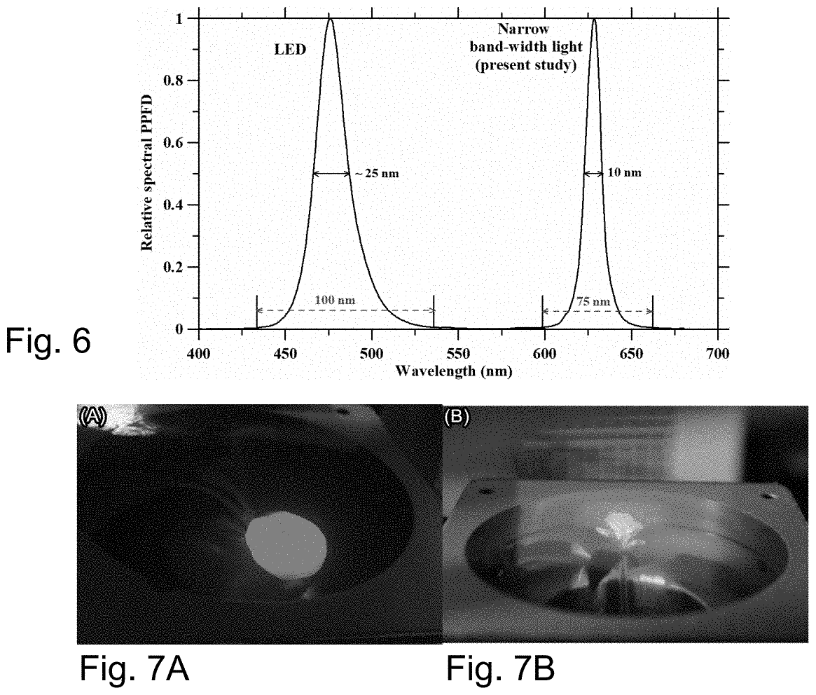

Each assembly had seven diodes on a thermal pad, which were attached to a concentrated lens (No. 263, Polymer Optics, Wokingham, Berkshire, UK). The configuration of the lighting system is illustrated in FIG. 5. Briefly, the LED assembly was placed on the entrance slit of the monochromator; and the monochromator was placed in a self-made frame, which allowed light outputs from the monochromator light to exit perpendicular to the leaf surface. The centroid wavelength and PPFD of the monochromatic light were adjusted with software provided by the monochromator manufacturer (Mono-Utility 5.0.4, Newport) and a DC power supply (DP832, Rigol Tech., Beaverton, Oreg., US), respectively. The light characteristic including centroid wavelength, PPFD, and FWHM of the monochromatic light was measured with a spectroradiometer (PS-300, Apogee, Logan, Utah, US). FIG. 6 compares the light distribution of a narrow bandwidth light (10 nm FWHM, used in this study) and a typical LED light (25 nm FWHM). The spectroradiometer was placed ˜20 cm below the monochromator light exit and the irradiated area from the monochromator was approximately 1.5 cm×1.5 cm (FIGS. 7A-B).

A preliminary test showed that nearly ˜80% PPFD was lost through the filtering process in the monochromator. Therefore, to achieve the test PPFD level (30 μmol·m⁻²·sec⁻¹) in the photosynthetically action radiation (PAR) spectrum (400-700 nm), an approach differing from that of typical LED operation methods was used. In addition, the LED assemblies were operated at three-fold higher than the maximum current outputs recommended by manufacturers (700-1000 mA). While overdriving the LED assemblies, coolant was circulated at −20° C. in a water jacket (ST-011, Guangzhou Rantion Trading Co., Guangdong, China) behind the mounted LED using an Isotemp bath circulator (4100R20, Fisher Scientific, Hampton, N.H.), to stabilize LED light characteristics and to prevent the LEDs from burning out while in overdrive. A low junction temperature allowed the LED assemblies to have a higher light output (˜20-60%) than if using a passive heat sink or fan-based cooling system. The overdriving process was limited to keep the LED junction temperature (Tⱼ) below 90% of the maximum operating junction temperature (<130° C.). The LED junction temperature was monitored while measurements were taken and calculated with the following equation:

Tⱼ=Tₛ+Ψⱼ₋ₛ·PD, Equation 1

where Tₛ is the temperature measured on the back surface of the LED board with a 10-K thermistor (Vishay, Malvern, Pa.), Ψⱼ₋ₛ is the total thermal resistance of the diode (12° C./W) and thermal pad (4° C./W), and PD is the total power dissipation (in watts) of the center LED on the assembly, acquired from its thermal resistance and forward voltage. The thermal resistance and forward voltage were monitored using a digital voltmeter (F106, Fluke, Everret, Wash., US) and an Ohm meter (XL-830L, Fluke), respectively.

Photosynthetic data for tomato and lettuce leaves were collected using the LI-6400 XT photosynthesis system (LI-COR, Lincoln, Nebr., US) equipped with a 6400-17 Whole Plant Arabidopsis Chamber (LI-COR). The LI-6400 system was calibrated with fresh soda lime (6-12 mesh) and a desiccant before conducting measurements. After calibration, CO₂ concentration and water vapor variations were kept to less than 0.05 μmol·sec⁻¹ and 0.05 mmol·sec⁻¹, respectively; the difference between these reference points and sample concentrations were expected to be within 0.01 μmol·sec⁻¹ when measurements were taken. If not, the LI-6400 was re-calibrated again until criteria was met. A whole plant rooted in wet rockwool was placed in the Whole Plant Arabidopsis Chamber, and the test plant leaf (˜1.5 by 1.5 cm) was placed against the top of the chamber cover, avoiding a heterogeneous light intensity distribution over the test leaf due to leaf tilt. If algae were observed on rockwool cube surface, there were removed using a razor blade to avoid interference. Parafilm was placed on top of the rockwool cube to ensure moisture isolation from the test chamber. The LI-6400 was stabilized for 5 min, and the first reading normally took 20 minutes; all subsequent readings took approximately 2 min. The LI-6400 controlled flow rate (400 μL min⁻¹), CO₂ concentration (400 μL·L⁻¹), relative humidity (˜50%), and block temperature (23° C.) in the chamber.

The monochromator was placed ˜−20 cm above the LI-6400 sensor head and its monochromatic light exit faced downward and parallel with the test leaf (FIG. 5). The spectroradiometer was placed on an adjustable jack and adjusted to the same distance as the test leaf, keeping PPFD constant. A plastic board (6 cm×6 cm) with a hole (1.5 by 1.5 cm) in the center was used as a light distribution guide, placed on the spectroradiometer. The LED assembly's angle was adjusted until the highest light intensity of the monochromatic light was aimed at the center of the irradiated area using the plastic board guide. The plastic board guide was placed on the LI-COR sensor head and positioned above the center of the test leaf. This maintained uniform irradiance levels for the test leaves using the same light distribution between wavelength treatments; it was also maintained for other leaves of the plant that were not irradiated.

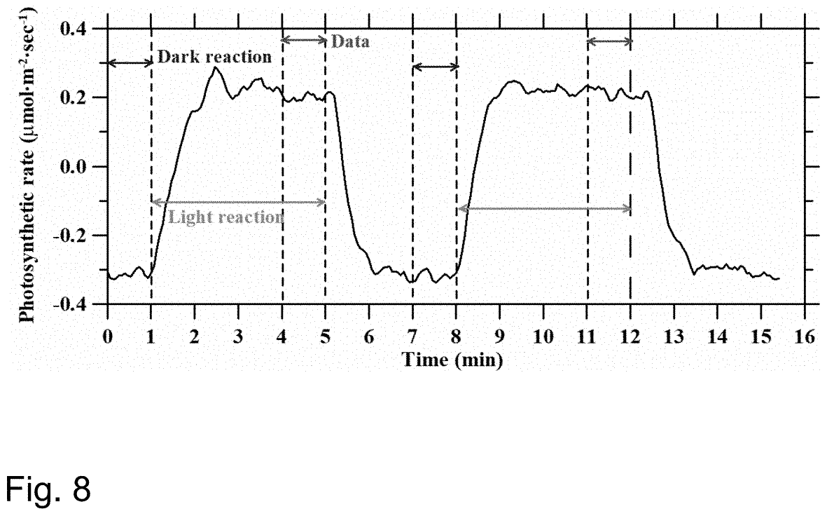

The monochromatic light with an assigned treatment wavelength and PPFD level was projected onto the test leaf. Each wavelength treatment lasted 5 min in duration, comprising 40 sec in the dark and 4 min 20 sec in the light, averaging 4 sec per signal (75 data points in total; FIG. 8). If the CO₂ concentration in the chamber suddenly increased or decreased by more than 0.1 μmol sec⁻¹ while measurements were being taken, measurements periods were extended or rejected. Between each wavelength treatment, plants were placed in the dark for 2-5 min to allow for dark respiration and to eliminate carryover effects from the previous wavelengths. Three biological replicates for each plant species and each wavelength were measured. For each replicates, the order of the wavelengths tested were in 1-nm increments and 1-nm wavelength reductions. These were partially randomized (half increments and half reduction in wavelength) to minimize potential interaction effects between wavelengths. For each replicate, 15-30 wavelength blocks were measured, depending on the LEDs used. Between each measured wavelength block, wavelength measurement was overlapped for at least two wavelengths to allow for combined data blocks. After each measurement, the irradiated leaf and others leaves from the test plant were separated and placed on a white paper. Leaf areas were measured using software ImageJ software (NIH, Bethesda, Md., US) and this was used to determine the photosynthetic rate on a per unit leaf area basis.

Net photosynthetic rates (Pₙₑₜ) of the test leaf were calculated with the following equation:

$${P}_{n e t} = \frac{{P}_{LI - COR , light} \cdot {LA}_{total} - {P}_{LI - COR , dark} \cdot {LA}_{dark}}{L {A}_{light}} - {P}_{Li - COR , dark} , \qquad Equation 2$$

Where P_{LI-COR, light} and P_{LI-COR, dark} are photosynthetic rates measured in light and dark (μmol·m⁻²·s⁻¹), respectively, and LA_{dark} and LA_{Total} are leaf areas (cm²) that were in the dark and the total leaf area, respectively. P_{LI-COR, light} was the average photosynthetic rate of last 20 data points for each measurement. After obtaining the net photosynthetic rate for each treatment wavelength across the block of wavelengths, the response rate from different wavelength blocks were overlapped, based on the photosynthetic rates of the duplicate wavelengths. For example, curves between 450-470 nm and 468-490 nm were overlapped according to data at 469 nm and 470 nm, and the photosynthetic rates of these two wavelengths were normally similar. However, some discrepancies did occur because of small differences in sample CO₂ concentrations, as provided by the 6400 XT in between data point measurements. If differences were observed, the response rates were shifted with a correction factor to allow overlapping with the same wavelengths (468-470 nm in this case). After overlapping the net photosynthetic response rates of each measured wavelength block, the action spectrum responses from three replicates were averaged.

The average PPFD of the tested wavelengths was 30.09±0.27 μmol·m⁻²·sec⁻¹, except for 570-590 nm, which ranged from 29.5-29.8 μmol·m⁻²·sec⁻¹. This slight decrease in irradiance was due to limited irradiance levels of the III-phosphide and III-nitride LEDs. The FWHMs of the narrow light spectra ranged from 9 nm to 11 nm.

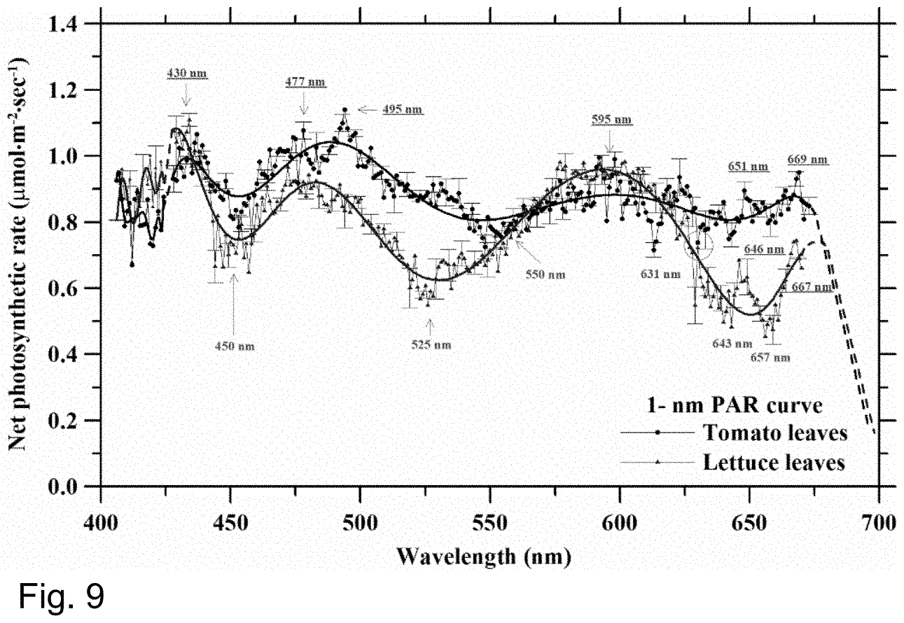

The wavelength impact on net photosynthetic rates at 30 μmol·m⁻²·sec⁻¹ when using 1-nm resolution was determined for tomato and lettuce plants grown under a fluorescent-light spectrum (FIG. 9). The 1-nm-resolution action spectra exhibited several distinct features. For both species, the action spectrum curves comprised four pronounced peaks (maximum photosynthetic rates), centered at 430 nm, 480/500 nm, 595 nm, 646/651 nm and 667/669 nm. Major valleys (minimum photosynthetic rates) were located at 450 nm, 525/550 nm, and 643/657 nm. Two major peaks were present in the 400-500 nm blue region, where the highest net photosynthetic rate was observed for both species. However, maximum peaks were opposed between species. In the blue region, the highest photosynthetic rates for the tomato and lettuce leaves were at 495 nm and 430 nm, respectively. The two blue peaks were separated by a distinct valley at 450 nm for both species. As the wavelength increased, the net photosynthetic rates decreased until reaching the lowest photosynthetic rates observed at 525 nm for lettuce, and at 550 nm for tomato. Both species showed a decreasing trend in the response curve in the green wavelength region (500-600 nm). An increase in photosynthesis was located at ˜595 nm. In the red wavelength region (600-700 nm), the curve of tomato had a valley and peak at ˜620 nm and 650 nm, respectively, for the lettuce leaves. Unlike lettuce, the action spectrum curve for tomato leaves oscillated more sharply than that for the lettuce leaves.

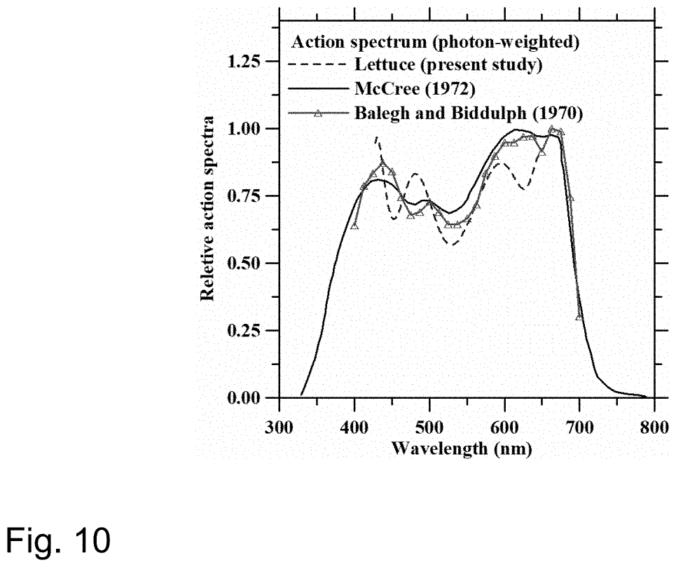

The relative action spectra of the tomato and lettuce leaves obtained in this study are compared to those of earlier studies in FIG. 10 (Balegh and Biddulph, 1970; McCree, 1972). The McCree curve is included as it is considered the standard, and the photosynthetic response curve from Balegh and Biddulph is compared because the PPFD was fixed along with measurement wavelength ranges. Others published data are presented as photometric units (Hoover, 1937) or radiant units (Inada, 1976); these have a different baseline when compared to the current data. It has been previously noted that using radiant units could underestimate the effectiveness of blue light (McCree, 1972). For the McCree curve, we converted units to spectral photon flux density to coordinate with our own light measurement units, following an approach established previously by Sager et al. (1982).

Overall, the action spectra obtained in the current study followed a similar trend to those presented in earlier studies, with the exception of some shifted photosynthetic maximums and minimums (see Erreur ! Source du renvoi introuvable. 10). Unlike the relatively smooth curve in the blue wavelengths and lower blue light efficiency relative to the red in the McCree curve, our data and those of Balegh and Biddulph (1970) had sharper peaks. Our data also had a higher blue light photosynthetic efficiency rate (˜10-20%) than these other two studies. Later research has since reported that variable responses in the blue photosynthetic rate could be caused by growing light conditions or leaf greenness (Inada, 1976; McCree, 1972); however, it may be caused by other environmental factors. McCree (1972) observed that plants grown in the field had lower responses in the blue wavelengths than in the growth chamber, but only for measurements taken at wavelengths less than ˜410 nm. However, Hogewoning et al. (2012) presented opposing data wherein different growing light conditions had no effect on quantum yield curve shape. Inada (1976) reported that the degree of leaf greenness affected blue light efficiency, but we did not observe such varied responses in blue light efficiency in our investigation. The leaf colour of the tomato and lettuce leaves were dark green and light green, respectively, but they both had nearly identical responses in the blue wavelengths.

Differences in spectral quality data between studies are much greater than differences between species within a study (Bugbee, 2016). Importantly, the aforementioned spectral quality determination studies were conducted using different plant species, environmental conditions in growth chambers, and experimental designs that may have contributed to these dissimilarities (Balegh and Biddulph, 1970; Hogewoning et al., 2012; McCree, 1972). When comparing previously published data to those collected in this work, we observed that the FWHM of the light spectrum could be the main factor that contributes to the varied responses in blue light efficiency relative to red light. Photosynthesis is a wavelength-dependence process (Inada, 1976; McCree, 1972). When using “boarder” narrow light spectrum [i.e. 25 nm used in McCree (1972)], the wavelength dependence of photosynthesis could be under-represented because of the interactive wavelength effect. Using narrower light spectrum (10 nm in the current study) may allow for independent determination of the individual wavelengths of light on the spectral efficiency of photosynthesis. Net photosynthetic rates at each measured wavelength for the McCree curve were measured using the light spectrum with 25 nm FWHM. McCree's data at each measured wavelength actually represents the convolution of the spectral-bandpass function with an unknown quantity across nearly 100 nm (FIG. 6). The narrower light spectrum (10 nm FWHM) used in the present study and the set of experiments performed by Balegh and Biddulph (1970) (10 nm FWHM) both showed pronounced peaks in the blue wavelengths. Distinct peaks were observed in other studies using the narrower light spectrum (<25 nm FWHM) (Bulley et al., 1969; Inada, 1976). When considering the main peak in the blue wavelengths, it ranged between 430-440 nm in earlier studies (Balegh and Biddulph, 1970; Bulley et al., 1969; Hoover, 1937; Inada, 1976). This is within range of our measured peak wavelength at 430 nm. Therefore, we believe the blue peak is at 430 nm, with the 10-nm-FWHM and 1-nm wavelength resolution conducted in the current study.

Environmental factors such as light irradiance level can affect plant growth and pigment accumulation, including lutein and β-carotene (Lefsrud et al., 2006; Lefsrud et al., 2005). However, the correlation between photosynthetic activity and extracted pigment absorbance peaks has not been determined. Two opposing opinions regarding their correlation exist. Some studies have pointed out that identifying the spectral quality of photosynthesis with particular pigments is difficult with leaves, as light-screening compounds are present (e.g. anthocyanins and betalains) (McCree, 1972; Rabinowitch, 1945; Smillie and Hetherington, 1999; Steyn et al., 2002). Furthermore, the plant pigment absorbance spectrum varies (10-20 nm) according to the extraction solvents used; this is due to differences in polarity and the loss of pigment protein-interactions (Porra, 2002). Notably, these solvents do not exist in leaf tissues or in plant photosystems. It is possible that this contributes to differences observed between the extracted and true pigment absorbance spectra.

The opposing hypothesis is that major pigments play an important role as they harvest light energy in photosynthesis (Massa et al., 2008; Singh et al., 2015), and this has led to targeted pigment absorbance peaks for maximum photosynthesis and plant productivity using 460-nm and 650-nm LEDs (Chen et al., 2017; Hernandez and Kubota, 2016; Naznin et al., 2016; Ouzounis et al., 2016; Piovene et al., 2015; Swan and Bugbee, 2017; Wang et al., 2016). In theory, these purplish lighting systems can induce high photosynthetic capacity and replace any other lighting system. Nowadays, however, amber-based HPS luminaires are still the preferable choice for greenhouse growers (Stober et al., 2017). Opposing evidence to the pigment theory, yet in accordance with the McCree curve has been reported (Han et al., 2017; Mizuno et al., 2011; Zhen and van lersel, 2017). Han et al. (2017) showed that higher dry mass and leaf growth rates (2-3 times) are obtained for lettuce plants grown under combined blue, amber, and red light when compared to combined red and blue light at 150 μmol·m⁻²·sec⁻¹. At a higher intensity range (50-750 μmol·m⁻²·sec⁻¹), using warm white LED light (low 460-nm and high broad 595-nm light) consistently induced higher photosynthetic rates for lettuce (Lactuca sativa cv, ‘Green Towers’) when compared to 453+638 nm light (Zhen and van lersel, 2017).

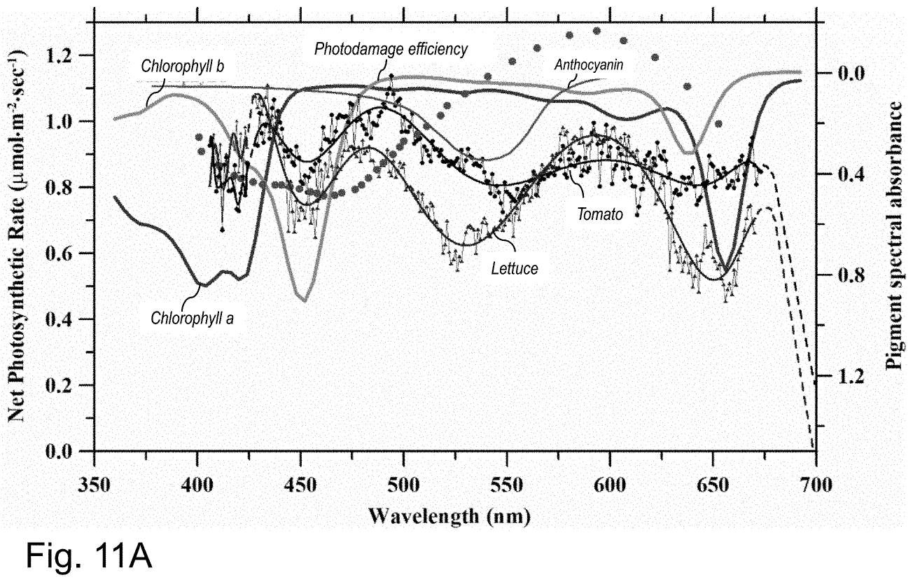

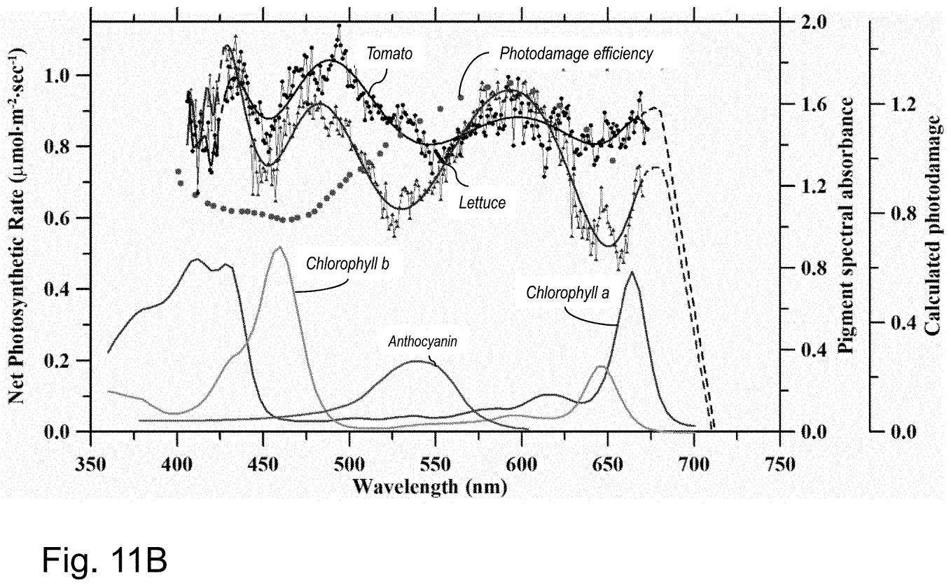

To further clarify the correlation between a plant's action and major pigment absorbance spectra, they were overlapped with other possible determining factors for photosynthetic capacity in FIGS. 11A-B. For the major pigment absorbance spectrum, neither the chlorophyll a nor b peak is in agreement with the action spectrum data. Surprisingly, the relationship between the 1-nm action spectrum and the extracted pigment absorbance spectrum happens to be in reverse. Specifically, peaks in the 1-nm action spectrum match the valleys of the chlorophyll a absorbance spectrum or it is between the chlorophyll a and b intersection. Similarly, valleys in the 1-nm action spectrum are in accordance with the chlorophyll absorbance peaks. The 430-nm peak and the 450-nm valley line up with the chlorophyll a/b intersection and the chlorophyll b peak, respectively. This relationship implies that major pigments might not be just used to funnel energy. We hypothesize that this coincidence could indicate that chlorophyll is used to dissipate light energy at 30 μmol·m²·sec⁻¹, which is considered high energy by photosynthetic reaction centers in plants.

The 595-nm light effect may be mediated by the oxygen-evolving complex (OEC), a Mn₄CaO₅⁻ cluster involved in photosynthesis (Umena et al., 2011). The OEC is located in photosystem II (PSII) and is responsible for photo-oxidation of water molecules. In addition, it has been suggested that manganese (Mn) contributes to photosynthesis (Bishop, 1928; Habermann, 1960; McHargue, 1922). Studies have attempted to determine the OEC structure using X-ray spectroscopy (DeRose et al., 1994; luzzolino et al., 1998; Sauer et al., 2008), but this remains challenging as X-rays can damage the OEC and the Mn-cluster is complex (Grabolle et al., 2006; Umena et al., 2011; Yano et al., 2005). Its absorptance characteristics also remain unknown.

The photo-damage efficiency of PSII provides indirect evidence of a link between 595-nm light and OEC involvement in photosynthesis (FIGS. 11A-B) (Hakala et al., 2005; Takahashi and Badger, 2011; Takahashi et al., 2010). Studies have demonstrated that primary photo-damage to PSII is associated with light absorptance by the Mn-cluster in OEC (Hakala et al., 2005; Tyystjarvi, 2008), and that photo-damage to PSII is extensive upon exposure to UV and amber light (Takahashi et al., 2010). Therefore, these studies indirectly imply that the photo-damage efficiency of OEC may be represented by its absorptance spectrum and that peak absorptance of the OEC occurs in the amber wavelengths. Although the water-splitting process within the OEC has not been clarified, we observe a high correlation between the photo-damage efficiency of OEC and the spectral quality of photosynthesis between 500-600 nm in the current study. As such, we hypothesize that the water-splitting process initiates light energy absorptance by the OEC without light energy transfer from antenna pigments. In this way, amber light allows the water-splitting event in the OEC to occur, resulting in the electron transport chain and subsequent use of photosynthetic machinery, at a moderate light intensity. This hypothetical event agrees with the measured spectral quality of photosynthesis, and pigments regrading amber light absorptance characteristics have not yet been identified.

A most detailed spectral quality of photosynthesis (1-nm resolution action spectrum) was obtained using LEDs and a monochromator. Data show peak photosynthetic rates at 430 nm and 650 nm, with increased levels at 595 nm and 480 nm. Observed peaks in the blue and red wavelengths are inversely correlated to the extracted pigment absorbance spectrum. The 595-nm peak observed in this investigation and reported in other photosynthetic studies suggests that the OEC initiates the use of photosynthetic machinery in the presence of amber light.

As can be understood, the examples described above and illustrated are intended to be exemplary only. The scope is indicated by the appended claims.

What is claimed is:

1. A method of growing a plant having at least one light absorbing pigment, the at least one light absorbing pigment absorbing optical energy at absorbing wavelengths, the method comprising:
illuminating the plant with growing light, the growing light having optical energy within at least two spectral regions each encompassing a given wavelength, the given wavelengths being out of tune with the absorbing wavelengths of the at least one light absorbing pigment, the at least two spectral regions being selected from a group consisting of a first spectral region below 400 nm, a second spectral region at about 430 nm, a third spectral region at about 480 nm, a fourth spectral region at about 595 nm, a fifth spectral region at about 640 nm, a sixth spectral region at about 660 nm and a seventh spectral region at about 675 nm.

2. The method of claim 1 wherein the growing light includes a first light beam having optical energy within one of the at least two selected spectral regions and a second light beam having optical energy within a remaining one of the at least two selected spectral regions.

3. The method of claim 2 wherein said illuminating comprises generating the first light beam using a first light-emitting diode and generating the second light beam using a second light-emitting diode.

4. The method of claim 2 wherein said illuminating comprises filtering the first light beam in a manner filtering out optical energy being out of tune with the one of the at least two selected spectral regions and filtering the second light beam in a manner filtering out optical energy being out of tune with the remaining one of the at least two selected spectral regions.

5. The method of claim 1 wherein at least one of the at least two selected spectral regions has a bandwidth of at least 1 nm.

6. The method of claim 1 wherein the at least one light absorbing pigment includes at least one of chlorophyll a, chlorophyll b, carotenoid and anthocyanin.

7. The method of claim 1 wherein the at least two selected spectral regions do not overlap with one another.

8. The method of claim 1 wherein said illuminating includes receiving sunlight and filtering the sunlight to remove the absorbing wavelengths of the at least one light absorbing pigment to provide the growing light.

9. A system for growing a plant having at least one light absorbing pigment, the at least one light absorbing pigment absorbing optical energy at absorbing wavelengths, the system comprising:
an illuminator illuminating the plant with growing light, the growing light having optical energy within at least two spectral regions each encompassing a given wavelength, the given wavelengths being out of tune with the absorbing wavelengths of the at least one light absorbing pigment, the at least two spectral regions being selected from a group consisting of a first spectral region below 400 nm, a second spectral region at about 430 nm, a third spectral region at about 480 nm, a fourth spectral region at about 595 nm, a fifth spectral region at about 640 nm, a sixth spectral region at about 660 nm and a seventh spectral region at about 675 nm.

10. The system of claim 9 wherein the illuminator includes a first illumination device propagating a first light beam having optical energy within one of the at least two selected spectral regions and a second illumination device propagating a second light beam having optical energy within a remaining one of the at least two selected spectral regions.

11. The system of claim 10 wherein said first illumination device is a first light-emitting diode and said second illumination device is a second light-emitting diode.

12. The system of claim 10 wherein said first illumination device has one or more filter elements filtering the first light beam in a manner filtering out optical energy being out of tune with the one of the at least two selected spectral regions, the second illumination device having one or more filter elements filtering the second light beam in a manner filtering out optical energy being out of tune with the remaining one of the at least two selected spectral regions.

13. A shelter for growing plants using sunlight, the plants having at least one light absorbing pigment absorbing optical energy at absorbing wavelengths, the shelter comprising:
one or more supports; and
one or more sheltering elements supported by the one or more supports and defining an area where plants are planted, the sheltering elements receiving the sunlight and filtering the sunlight to remove optical energy at the absorbing wavelengths of the at least one light absorbing pigment, thereby leaving a remaining portion of the sunlight to reach the plants, the remaining portion of the sunlight having optical energy within at least two spectral regions being selected from a group consisting of a first spectral region below 400 nm, a second spectral region at about 430 nm, a third spectral region at about 480 nm, a fourth spectral region at about 595 nm, a fifth spectral region at about 640 nm, a sixth spectral region at about 660 nm and a seventh spectral region at about 675 nm.

14. The shelter of claim 13 wherein said sheltering elements are partially or wholly made of a transparent layer being optically transparent only at the at least spectral regions.

15. The shelter of claim 14 wherein the transparent layer has a body of sunlight transparent material, and one or more filter elements deposited on the body of sunlight transparent material, the filter elements filtering the sunlight to remove optical energy at the absorbing wavelengths of the at least one light absorbing pigment.
